(19) United States
(12) Patent Application Publication
(10) Pub. No.: US 2014/0071660 A1
(43) Pub. Date: Mar. 13, 2014

(54) Apparatus for Vibrating Fluid to Alter Light Transmission

(71) Applicant: Todd Davey, Austin, TX (US)

(72) Inventor: Todd Davey, Austin, TX (US)

(21) Appl. No.: 13/612,733

(22) Filed: Sep. 12, 2012

(51) Int. Cl. F21V 33/00

(52) U.S. Cl. 362/101

(57) ABSTRACT

An apparatus comprises a first enclosure comprising a first side. The first side comprises a first hole. A vibration device is joined to the first side and is configured for generating a vibration for transmission through the first hole. A light unit is disposed within the apparatus for generating a source of illumination. A second enclosure comprises a second enclosure first side and a second enclosure second side. The second enclosure second side comprises a second hole. The second enclosure comprises materials to enable light transmission. The second enclosure is positioned adjacent to the first enclosure with the first hole and the second hole adjacent. A quantity of fluid is contained within the second enclosure in which vibration alters transmission of the light through the fluid.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to vibrating light devices. More particularly, one or more embodiments of the invention relate to audio vibrating light devices.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that typically light filter devices project a fixed pattern or patterns. Often in order to alter the fixed pattern a user must structurally modify the device. Structural modification can often be difficult and time consuming. Additionally, structural modification typically allows for only one, or only a few varying patterns.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary vibrating light device, in accordance with an embodiment of the present invention;

FIG. 2 illustrates an exemplary detachable receptacle, in accordance with an alternative embodiment of the present invention;

FIG. 3 illustrates an exemplary receptacle, in accordance with an embodiment of the present invention; and

FIG. 4 illustrates an exemplary vibrating light device 400, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

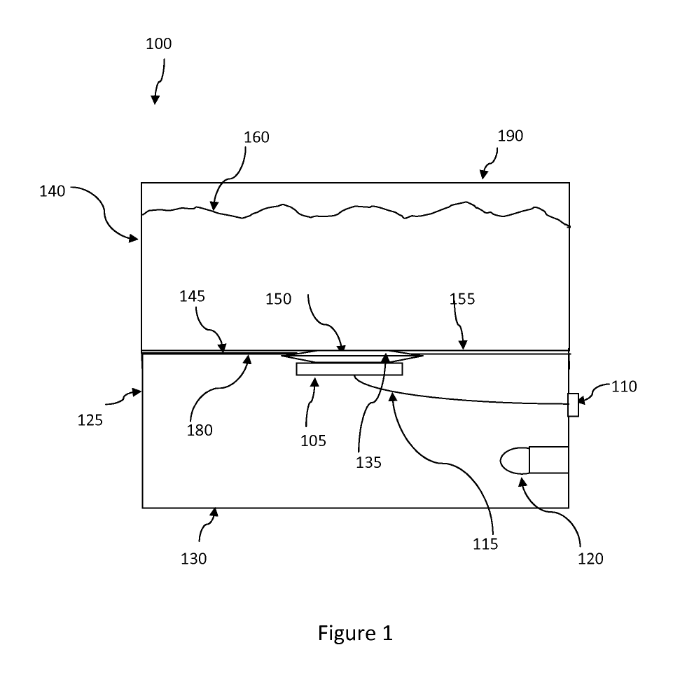

FIG. 1 illustrates an exemplary vibrating light device 100, in accordance with an embodiment of the present invention. The vibrating light device includes a vibrating component 105. In at least one embodiment of the present invention, the vibrating component may be a speaker. Suitable speakers include, but are not limited to, an electrodynamic speaker, a flat panel speaker, a planar magnetic speaker, an electrostatic flat panel speaker, a diaphragm speaker, a cone speaker, a plasma arc speaker, a piezoelectric speaker, and a combination thereof. In at least one embodiment of the present invention, the diameter of a suitable speaker may be from approximately 2 inches to 12 inches with a frequency response of 80 Hz-18 kHz, and power from 1-50 watts power. In other embodiments, the frequency range may be greater and the power may exceed 50 watts. In at least one embodiment of the present invention, the vibrating component may be configured to produce sound waves. In some embodiments, the vibrating component may be coupled to a power source. Suitable power sources include, but are not limited to, an alternating current power source, a direct current power source, a cable, a battery, a fuel cell, a generator, an alternator, a solar power source, and a combination thereof. In some embodiments, the vibrating component may be coupled to a user interface 110. In at least one embodiment of the present invention, the user interface 110 may be configured to control the vibrating component 105. Suitable user interfaces include, but are not limited to, an audio jack, speaker clips, a universal serial bus port, a laptop, a monitor, a stereo receiver, a notebook, a phone, a smartphone, an electronic reader, a tablet, a keyboard, a mouse, a touchpad, a joystick, a keypad, and a combination thereof. In some embodiments, the user interface may be coupled to a power source. In at least one embodiment of the present invention , power sources in the current embodiment would be direct or alternating power source or a battery or batteries. Suitable power sources include, but are not limited to, an alternating current power source, a direct current power source, a cable, a battery, a fuel cell, a generator, an alternator, a solar power source, and a combination thereof. In at least one embodiment of the present invention, the vibrating component 105 may be coupled to the user interface 110 with at least one cable 115. In at least one embodiment of the present invention, cable 115 may comprise wire between 10 and 32 gauge. The wire in the present embodiment would be capable of safely and effectively transmitting sound/electricity from the user interface 110 to the vibrating component 105. In some embodiments, the user interface 110 may be coupled to a user device. Suitable user devices include, but are not limited to, a digital audio player, a stereo receiver, a phone, a smartphone, an electronic reader, a tablet, a laptop, and combinations thereof. In at least one embodiment of the present invention, the user device may be coupled to the user interface across one or more networks.

In some embodiments, the vibrating light device 100 may include a light source 120. Suitable light sources include, but are not limited to, a light emitting diode, a gas discharge lamp, an electroluminescent lamp, an incandescent lamp, an electron stimulated light, solar light, a high-intensity discharge lamp, a bulb, and a combination thereof. In at least one embodiment of the present invention, light output may be a light emitting diode with range of light output would allow the light to be strong enough to refract and reflect through the fluid 160 in the receptacle 140. In the present embodiment the range of light output may be from 35 to 300 lumens. In other embodiments, the light output may be more or less. Any light source and output is acceptable as long as the construction of the case 125 can withstand the heat output of the light source and the fluid volume and density is adjusted to produce the vibrating light effect. The light output may be considered as a function of the volume of fluid 160 that may need to be increased to refract and/or reflect the additional light depending on the refractory properties of the fluid. Considerations of the strength of the film membrane 155 and receptacle 140 that may need to be considered and increased for structural and functional integrity of the device. In some embodiments, the light source may be coupled to a power source. Suitable power sources include, but are not limited to, an alternating current power source, a direct current power source, a cable, a battery, a fuel cell, a generator, an alternator, a solar power source, and a combination thereof. In some embodiments, the light source may have at least one color. In at least one embodiment of the present invention, the light source may be configured to change color. At least one embodiment of the present invention, may contain multiple light emitting diodes of various colors. Other embodiments may include light filter devices and/or fluid 160 that is colored. The user interface may be configured to change the color of the light source in some embodiments. In an alternative embodiment, light source 120 may be operative to change intensity with the intensity of the vibration of vibrating device 105. When vibrating device 105 is not vibrating, light source 120 may emit a preset or user adjustable intensity of light. As the vibrating device 105 begins to vibrate, the light intensity may increase and follow the level of the vibrations. In some alternative embodiments, light source 120 may be configured to emit an intensity that follows the instantaneous level of the vibrations. In other alternative embodiments, light source may follow an average level of the vibrations. In some other alternative embodiment, a period of time, over which the level is averaged, may be adjustable by the user.

In at least one embodiment of the present invention, a case 125 may be provided. Suitable materials for the case 125 include, but are not limited to, plastic, rubber, wood, metal, ceramic, glass, and combinations thereof. In at least one embodiment of the present invention, material may be of a property to maintain structural integrity under the pressure of the loaded receptacle 140 and the heat output from the light device 120 and the opacity properties to prevent light from the light source 120 from omitting in areas other than designed and desired areas to effectively produce the vibrating effect. In at least one embodiment of the present invention, the size of the case is between 3 to 24 inches in length, 3 to 24 inches in width, or diameter of 3 to 24 inches for round embodiments, and 2 to 12 inches in height. Other embodiments may have other dimensions. The length and width may extend between 1 and 12 inches beyond the outer edge of the vibrating component 105, in some embodiments a speaker. In some embodiments, the case 125 may not be translucent. The case may not be transparent in some embodiments. In at least one embodiment of the present invention, the case 125 may be opaque. The case may be rigid in some embodiments. In one embodiment the rigid frame is made of a metal such as aluminum or steel, in other embodiments of the present invention rigid materials such as plastic may be used instead. In an alternative embodiment, the case may be flexible. In at least one embodiment of the present invention, the case may have a shape. Suitable shapes for the case include, but are not limited to a cube, a tower, a rectangular box, a pyramid, a prism, a cylinder, a sphere, and combinations thereof. In at least one embodiment of the present invention, the case may include at least one side 130. In some embodiments, at least one side 130 may be translucent. In at least one embodiment of the present invention, at least one side 130 may be transparent. In some embodiments, at least one side 130 may be opaque. In at least one embodiment of the present invention is to have side 180 where the aperture is disposed transparent or translucent with other sides 130 that encapsulate the light device 120 being opaque. In some embodiments, the vibrating component 105 may be disposed, at least partially, in a side 180. An aperture 135 may be disposed in at least one side 180 in some embodiments. The vibrating component 105 may be disposed, at least partially, in the aperture 135 in at least one embodiment of the present invention. In some embodiments, at least one of the vibrating component, the user interface, the cable, and the light source may be disposed, at least partially, in the case 125.

In some embodiments, the vibrating light device 100 may include a receptacle 140. In at least one embodiment, material for the receptacle 140 is glass or any transparent stable plastic, such as acrylic or polycarbonate. Suitable materials for the receptacle 140 include, but are not limited to, plastic, rubber, metal, wood, ceramic, glass, and combinations thereof. In some embodiments, the receptacle 140 may be translucent. The receptacle may be transparent in some embodiments. In at least one embodiment of the present invention, the receptacle may include at least one surface 145. At least one surface 145 of the receptacle may be translucent in some embodiments. In some embodiments, at least one surface 145 of the receptacle may be transparent. In some embodiments, material for surface 145 is glass or any transparent stable plastic, such as acrylic or polycarbonate. The vibrating component 105 may be disposed, at least partially, in a surface 145 in some embodiments. In at least one embodiment of the present invention, the receptacle may have a shape. Suitable shapes for the receptacle include, but are not limited to a cube, a tower, a rectangular box, a pyramid, a prism, a cylinder, a sphere, and combinations thereof. In some embodiments, the receptacle 140 may be open, at least partially, to the ambient environment. In at least one embodiment of the present invention, the receptacle may include a hole 150. The hole may be disposed in at least one surface 145 in some embodiments. The vibrating component 105 may be disposed, at least partially, in the hole 150 in at least one embodiment of the present invention. In some embodiments, at least one of the vibrating component, the user interface, the cable, and the light source may be disposed, at least partially, in the receptacle 140. In some embodiments the receptacle will be leak proof.

In some embodiments, a film 155 may be provided. In at least one embodiment of the present invention, the film 155 may be translucent. The film may be transparent in some embodiments. Suitable materials for the film include, but are not limited to, plastic, polyester, polymers, and combinations thereof. In some embodiments, the range of thicknesses may be 0.75 mils to 10 mils while being leak proof, allowing light transmission and taunt over the hole 150 and structurally supporting the fluid 160. Any range is acceptable that allows for the structural support of the fluid 160, light transmission and be taunt over the hole 150. In some embodiments, the film 155 may be stretchable. In at least one embodiment of the present invention, the film may be leak proof. The film 155 may be disposed in the receptacle in at least one embodiment of the present invention. In some embodiments, the film may be joined to a surface 145 of the receptacle. In at least one embodiment of the present invention, the film 155 may be in contact with the vibrating component 105. Some embodiments of the present embodiment may have a transparent stretchable leak proof film 155 in tight contact with surface 145. The vibrating device 105 may be secured on surface 180 within the aperture 135 flush with or just below surface 145 in contact with the fluid 160 contained within the receptacle 140. In the current embodiment the receptacle 140 has a cover 190. In some embodiments of the current invention the receptacle 140 may be leak proof, air tight and completely encapsulated. In some other embodiments, receptacle 140 may not have cover 190. In some non-limiting examples, receptacle 140 may be configured as a pool for a fountain or other type of ornamental water decor.

In at least one embodiment of the present invention, the film may be in contact with a fluid 160. In some embodiments, the fluid 160 may be disposed, at least partially, in the receptacle 140. In at least one embodiment of the present invention, the fluid 160 may be translucent. The fluid may be transparent in some embodiments. In some embodiments, the fluid in the current embodiment of the invention is alcohol based. Suitable fluids include, but are not limited to, water, vinegar, alcohol, liquid wax, and combinations thereof. In some embodiments the fluid may be colored. In some embodiments, the fluid may be configured to, at least partially, reflect light. In at least one embodiment of the present invention, the fluid may be configured to, at least partially, refract light.

In some embodiments, when a user activates the vibrating component the vibrating component may cause a vibration. In at least one embodiment of the present invention, the vibration may move through the liquid. The movement of the vibration through the liquid may cause a pattern in some embodiments. In at least one embodiment of the present invention, the light source may illuminate, at least partially, into the liquid. In at least one embodiment of the present invention, the vibrating device 105 may be activated by the user creating a visible vibration through the liquid where the light source is strong enough to illuminate the liquid and refract and project the vibrating illuminated pattern on a surface.

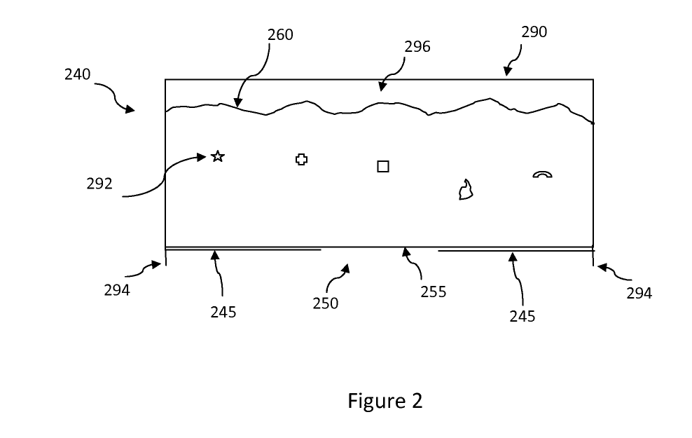

FIG. 2 illustrates an exemplary detachable receptacle, in accordance with an alternative embodiment of the present invention. Receptacle 240, in an alternate embodiment, is shown detached from vibrating light device 100 of FIG. 1. Receptacle 240 may be removed for replacement or for access to component in the base of vibrating light device 100. In at least one alternate embodiment, receptacle 240 may be removed from the base of vibrating light device by lifting receptacle 240 up from the base. In some embodiments, lip 294 extends over the wall of the base to provide stability when resting on the base. In other embodiments, receptacle may be secured to the base with devices such as, but not limited to, clasps, buckles, pins, screws bolts, etc. Transparent or translucent film membrane 255 contains fluid 260 within receptacle 240. Transparent or translucent cover 290 seals the top of receptacle 240. In some embodiments, cover 290 may be removable for enabling emptying or replacement of fluid 260. Hole 250 in transparent or translucent surface 245 enables vibrating device 105 to vibrate membrane 255 and fluid 260. In some embodiments, surface 245 may include refractive elements to distribute light over hole 250. In some embodiments air gap 296 enables the top of fluid 260 to fluctuate with the vibration of the fluid. In some embodiments, fluid 260 may be homogeneous and may be clear or colored. In other embodiments, fluid 160 may contain two or more fluids with different viscosities and that are non-reactive to each other so that they don't mix. In some other embodiments, each fluid may have a different color. In some embodiments, artifacts 292 may be introduced into fluid 260. Artifacts 292 may be configured to have generally neutral buoyancy in fluid 260 such that they may float within the fluid. Artifacts 292 may be of various shapes and sizes to produce different patterns in light passing through fluid 260. In some other embodiments, artifacts 292 may have a reflective surface.

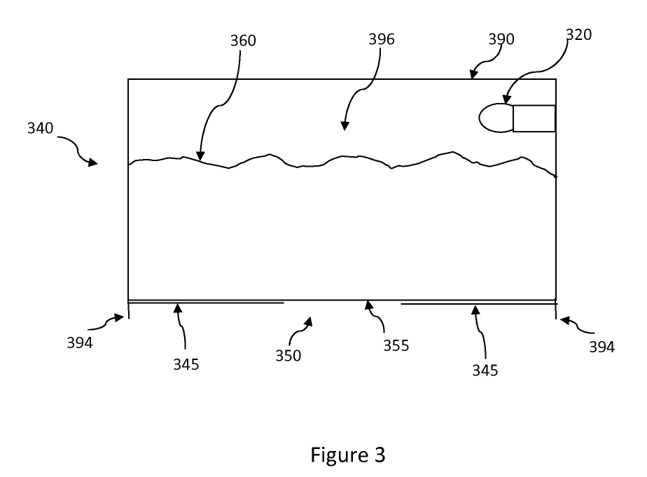

FIG. 3 illustrates an exemplary receptacle, in accordance with an embodiment of the present invention. Receptacle 340 is shown detached from vibrating light device 100 of FIG. 1. Receptacle 340 may be removed for replacement or for access to components in the base of vibrating light device 100. In other embodiments, receptacle 340 may be fixed to the base of vibrating light device. In some embodiments, lip 394 extends over the wall of the base to provide stability when resting on the base. In other embodiments, receptacle may be secured to the base with devices such as, but not limited to, clasps, buckles, pins, screws bolts, etc. In the present embodiment, light source 320 is positioned within receptacle 340 and light source 120 is omitted from case 125. In some embodiments, film membrane 355 and surface 345 are transparent or translucent. In these embodiments, case 125 is transparent or translucent and light from light source 320 passes through fluid 360 and exits case 125. In these embodiments, cover 390 may be reflective. In a non-limiting example, receptacle 340 may be secured to a ceiling for lighting a room. In some other embodiments, film membrane 355 may be reflective and cover 390 may be transparent or translucent. In these embodiments, light from light source 320 passes through fluid 360, is reflected by membrane 355 and exits cover 390. In some alternated embodiments, light source 320 may include means for directing the light away from cover 390 and into fluid 360.

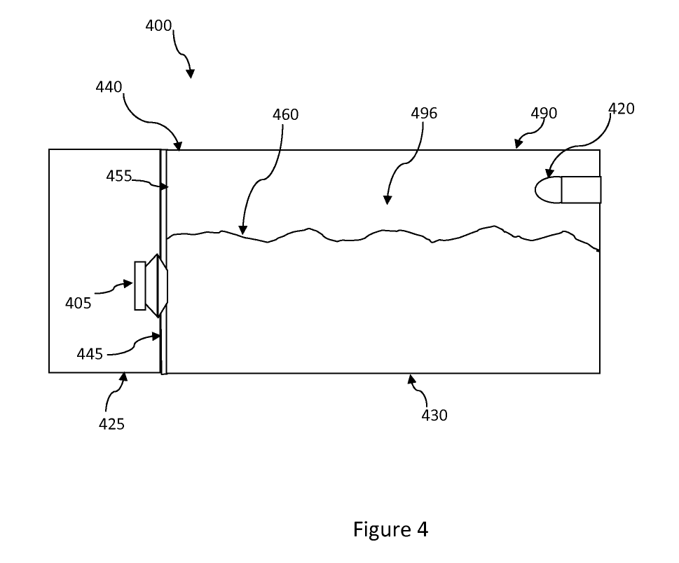

FIG. 4 illustrates an exemplary vibrating light device 400, in accordance with an embodiment of the present invention. Receptacle 440 includes light source 420 in positioned in space 496. The vibrating device 405 may be secured to surface 445 in case 425 in contact with film membrane 455 in contact with fluid 160 contained within the receptacle 440. In some embodiments, surface 430 is transparent or translucent. In these embodiments, light from light source 420 passes through fluid 460 and exits surface 430. In these embodiments, cover 490 may be reflective. In a non-limiting example, receptacle 440 may be secured to a ceiling for lighting a room. In some other embodiments, surface 430 may be reflective and cover 490 may be transparent or translucent. In these embodiments, light from light source 420 passes through fluid 460, is reflected by surface 430 and exits cover 490. In some alternated embodiments, light source 420 may include means for directing the light away from cover 490 and into fluid 360. In some alternate embodiments, light source 420 may be immersed in fluid 460

It should be understood that, in practice, any of the foregoing embodiments may require routine design modifications depending on the particular needs of the application and/or particular manufacturability issues that may arise in commercial implementations, and those skilled in the art will readily recognize how to modify any of the foregoing embodiments in light of the teachings of the present invention and according conventional techniques to achieve a practical design for the particular application. By way of examples, and not limitation, some such issues relate to coatings to prevent fogging within the liquid container, manufacturing pressures/supports for maintaining the integrity of the chamber for changes in atmospheric pressure resulting from atmospheric pressure differentials and temperature differentials between the air in the chamber and outside the chamber.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing vibrating light devices according to the present invention will be apparent to those skilled in the art. The invention has been described above by way of illustration, and the specific embodiments disclosed are not intended to limit the invention to the particular forms disclosed. The particular implementation of the vibrating light devices may vary depending upon the particular context or application. By way of example, and not limitation, the vibrating light devices described in the foregoing were principally directed to audio vibrating light device implementations; however, similar techniques may instead be applied to other vibration producing devices including, but not limited to, motors, pumps, and devices producing electrical resonance, which implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
a first enclosure comprising at least a first enclosure side, said first enclosure side comprising a first hole;
a vibration device being joined to said first enclosure side, said vibration device being configured to be operable for generating a vibration for transmission through said first hole;
a light unit being disposed within the apparatus, said light unit being configured to be operable for generating a source of illumination;
a second enclosure comprising at least a second enclosure first side and a second enclosure second side, said second enclosure second side comprising a second hole, said second enclosure comprising materials being configured to be operable to enable light transmission, said second enclosure being positionable adjacent to said first enclosure with said first hole and said second hole being adjacent;
a membrane being joined to said second enclosure second side to at least cover said second hole; and
a quantity of fluid being contain within said second enclosure in which vibration of said membrane is conducted to said fluid and alters transmission of said light through said fluid.

2. The apparatus as recited in claim 1, further comprising an interface unit being operable for transferring a signal to said vibration device to generate said vibration.

3. The apparatus as recited in claim 2, in which said signal comprises frequency at least within an audible range.

4. The apparatus as recited in claim 3, in which said vibration device comprises an audio speaker.

5. The apparatus as recited in claim 1, in which an air gap is formed between said fluid and said second enclosure.

6. The apparatus as recited in claim 1, in which said first enclosure side, said second enclosure first side and said second enclosure second side are transparent and said light unit is positioned within said first enclosure.

7. The apparatus as recited in claim 1, in which said second enclosure first side is transparent and said light unit is positioned within said second enclosure.

8. The apparatus as recited in claim 1, in which said fluid is translucent.

9. The apparatus as recited in claim 1, in which said light unit comprises a plurality light generators for generating a plurality of different colors of light.

10. The apparatus as recited in claim 9, in which said light unit is configured to be operable for selecting a one of said colors for illumination.

11. The apparatus as recited in claim 8, in which said fluid is colored.

12. An apparatus comprising:
a first enclosure comprising at least means being configured to be operable for enabling vibration transmission;
means being configured to be operable for generating a vibration for transmission through said enabling means;
means being operable for transferring a signal to said generating means to generate said vibration;
means being configured to be operable for generating a source of;
a second enclosure comprising at least means being configured to be operable for enabling light transmission, and vibration transmission from said first enclosure; and
means being configured to be operable for altering transmission of said light in said second enclosure in response to said vibration.

13. An apparatus comprising:
a first enclosure comprising at least a first transparent enclosure top, said first transparent enclosure top comprising a first hole proximate a midpoint of said first transparent enclosure top, said first transparent enclosure top further comprising a material being configured to be operable to enable light transmission;
a vibration device being joined to said first enclosure top proximate said first hole, said vibration device being configured to be operable for generating a vibration for transmission through said first hole;
an interface unit being operable for transferring a signal to said vibration device to generate said vibration;
a light unit being disposed within said first enclosure, said light unit being configured to be operable for generating a source of illumination through said first transparent enclosure top;
a second enclosure comprising at least a second transparent enclosure top and a second enclosure bottom, said second enclosure bottom comprising a second hole proximate a midpoint of said second enclosure bottom, said second transparent enclosure top and said second enclosure bottom comprising materials being configured to be operable to enable light transmission, said second enclosure being positionable on a top of said first transparent enclosure top to enable light to be transmitted through said second enclosure bottom and vibration to be transmitted through said second hole;
a transparent membrane being joined to a top of said second enclosure bottom to at least cover said second hole and receive vibration from said second hole; and
a quantity of fluid being contain within said second enclosure, in contact with said transparent membrane, and forming an air gap between a top surface of said quantity of fluid and said second transparent enclosure top in which vibration of said membrane is conducted to said fluid and alters transmission of said light through said fluid.

14. The apparatus as recited in claim 13, in which said signal comprises frequency at least within an audible range.

15. The apparatus as recited in claim 14, in which said vibration device comprises an audio speaker.

16. The apparatus as recited in claim 13, in which said second enclosure bottom is transparent.

17. The apparatus as recited in claim 13, in which said fluid is translucent.

18. The apparatus as recited in claim 13, in which said light unit comprises a plurality light generators for generating a plurality of different colors of light.

19. The apparatus as recited in claim 18, in which said light unit is configured to be operable for selecting a one of said colors for illumination.

20. The apparatus as recited in claim 17, in which said fluid is colored.
